(19) United States
(12) Patent Application Publication
(10) Pub. No.: US 2004/0081550 A1
(43) Pub. Date: Apr. 29, 2004

(54) Dual flow submerged encapsulated hydro water mill

(76) Inventor: Mario John Bini, Brooklyn, NY (US)

Correspondence Address: Mario J. Bini, 7021 Perry Terrace, Brooklyn, NY, 11209, US

(21) Appl. No.: 10/282,888

(22) Filed: Oct. 29, 2002

(51) Int. Cl. F03D 7/00

(52) U.S. Cl. 415/3.1

(57) ABSTRACT

An environmentally non-intrusive Dual Flow Submerged Encapsulated Hydro Mill Station, for a stationary deployment in the ocean or a river. A submerged constructed invention that can operate and turn a turbine in both tide flow directions without the necessity of turning or moving the structure. An encapsulated water mill, with minimal drag will be turned by the force of the current. An air hose that is connected to an air pump that will be built into a buoy. The buoy remains on the water surface above the invention and will pump air into an air hose. The air hose will drop down and be connected to the underside and aft section of the encapsulated chamber of The Dual Flow Submerged Encapsulated Hydro Water Mill. The air will be distributed on both sides and throughout the center equally of the encapsulation chamber. The air will be pumped into the encapsulated chamber at a high flow rate. The air will rise and (1) displace much of the water in the upper section of the encapsulation chamber and allow the paddles to move with little or no resistance. (2) While keeping the integrity of the upper section of the encapsulation chamber. With the design of the Water Flow Entrance Chambers, it will increase the speed of the natural current flow that is just outside of the Water Flow Entrance Chamber, by many times at the High Pressure Water Flow Section. The needed speed in the High Pressure Water Flow Section will depend on the Height, Width and Length of the Water Flow Entrance Chambers to create the correct torque and Rpm's., which will accommodate a turbine that requires a very high torque.

### BACKGROUND

For many decades that have past, teams of Scientist, Engineers along with other professionally interested parties have sought ways to harness the natural kinetic resource through Hydropower to meet the future needs of the increasing electric demand. Notably, the implementation of many size hydroelectric facilities has been amply demonstrated to be a successful means to produce natural clean electrical power intended to meet the worlds future needs. The success of the many different size hydroelectric generation notwithstanding, such massive undertakings have had numerous drawbacks. Many of these projects required extremely high financial cost. Other projects could only come close to an estimated completion time, which usually encumbered an even high financial cost then what was estimated. Other projects created much thought as to the damages to the balanced ecosystem. Many farmers and ranchers have access to fast flowing streams and some access to small to medium size water falls to generate enough electrical energy through hydropower. In the past decade, we see more solar paneling creating even more electrical energy. Further, where possible, a combination of these conversions is sometimes utilized.

### OBJECTS OF THE INVENTION

The present invention will be 100 percent submerged and at a depth of ocean, that will cause no necessary concern for a passing vessel.

The invention will be attached to two turbines that are also Encapsulated along the North and South sides of the invention.

The invention will create a high torque.

Will operate 21 to 22 hours a day.

This invention requires no special lightweight types of metals and no ballast tanks.

All moveable parts are designed to move with the natural forces of the current.

### SUMMARY OF THE INVENTION

The object of this invention is to provide a clean power conversion system that will be used in the ocean and can not be seen from the surface of the ocean. It will be stationary and no movement is required. It will convert the incoming and outgoing flow of the ocean tides to create electrical power, once connected to a turbine. The preferred embodiment also incorporates an augmentor ring. The augmentor ring extends generally in a radial symmetry with the axial alignment to the turbine shaft.

### DETAILED DESCRIPTION OF THE PREFERRED EMBODIMENT

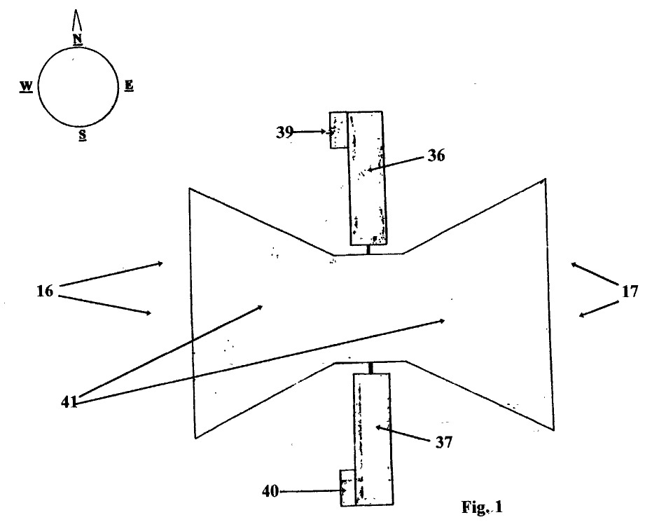

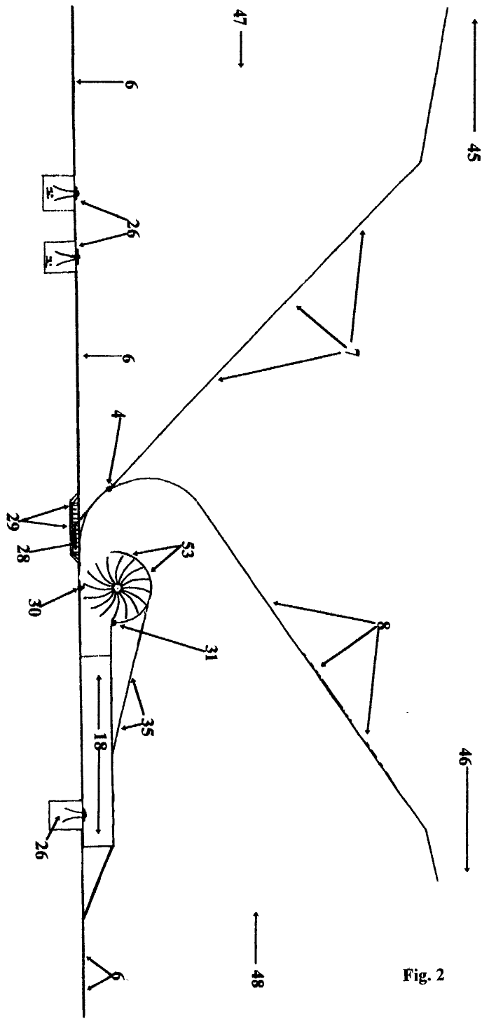

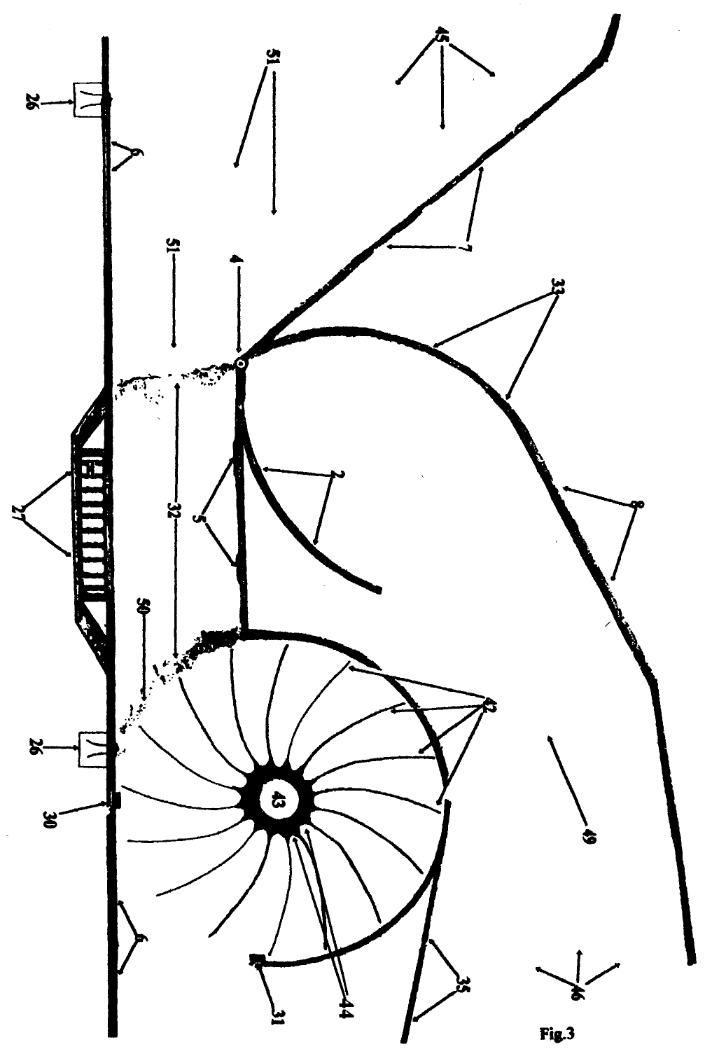

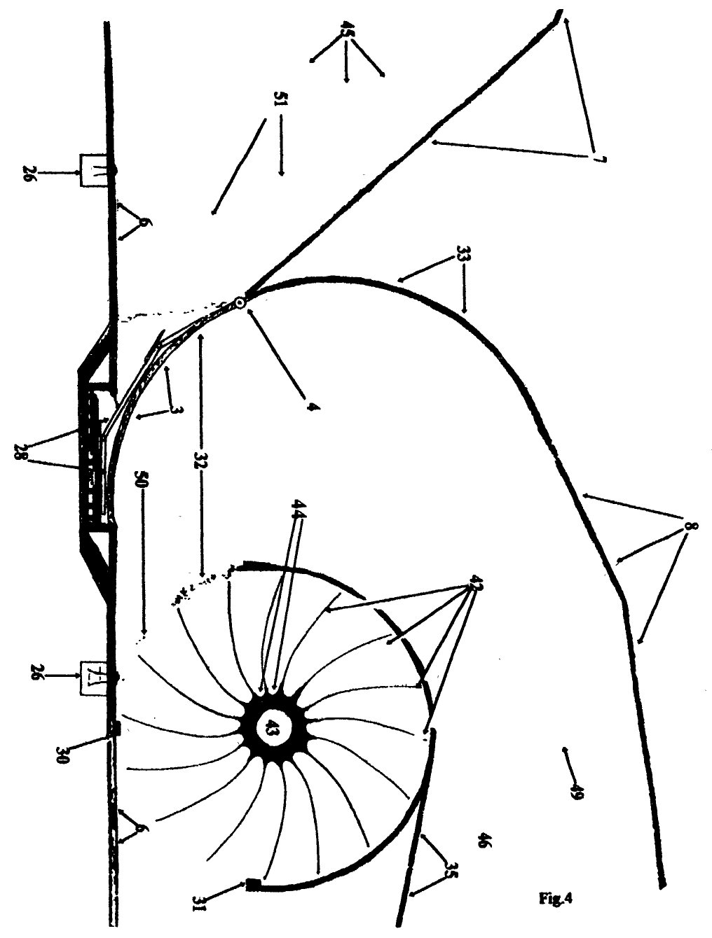

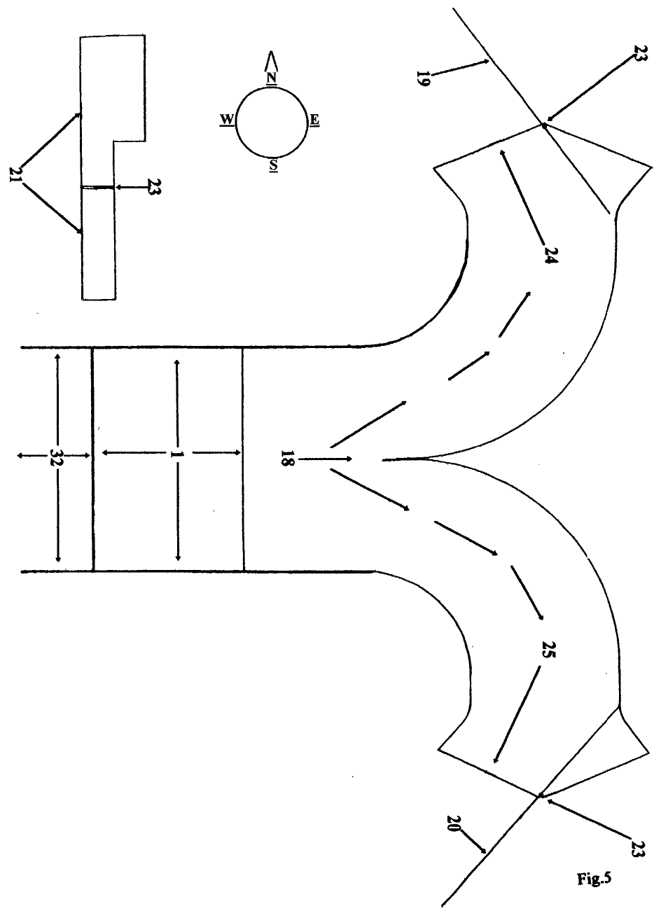

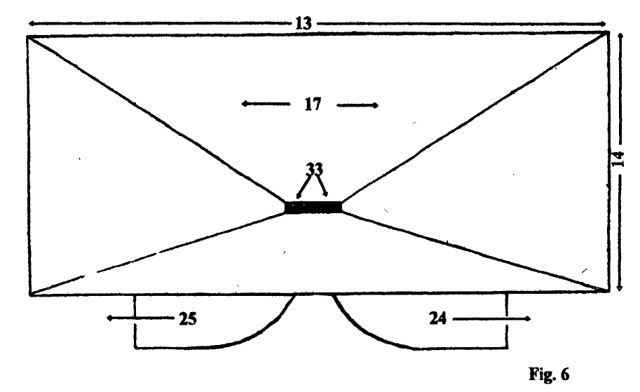

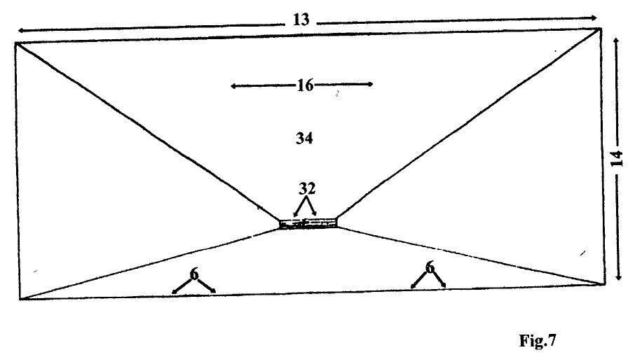

FIG. 1 Illustrates a preferred embodiment of the invention in an exemplary environment for operation. Specifically, FIG. 1 shows a compass to demonstrate the positioning of the entire station. 41 a top view of the entire Dual Flow Submerged Encapsulated Hydro Water Mill Station. With both 36 and 37 Turbines. With 39 and 40 work areas. Augmentor rings (not shown). Also illustrating both directions of the incoming and outgoing tides. Only one turbine will be operating at a time. FIG. 2 Illustrates a lateral view specifically 45, 46, 49 and 51. 4 Hinge. Made for a slip fit for ease of operation. 6 The Base. 7 Top of the WEST Water Flow Entrance Chamber. 8 Top of the EAST Water Flow Entrance Chamber. 26 Anchor Support, will be placed evenly apart and evenly placed, connected from the 6 Base to the ocean floor, embedded in concrete. 28 Spring's and the Spring Housing. 29 Brace for the Spring Housing. 30 Air Housing dispenser for the lower Encapsulation Chamber. 31 Air Housing dispenser for the EAST section of the Encapsulation Chamber. 18 Water Flow Exit Chamber and 35 Encapsulation chamber brace. FIG. 3 Illustrates a closer side view of the invention specifically, 45, 46, 49 and 51. 4 Hinge for the 2, The water flow direction panel. A molded aluminum curved corrugated panel which makes it weightless in water and will permanently encapsulate air. The slightest movement from the water pressure against the 2 panel will move the panel to the correct position for the incoming water flow. The flow direction panel will be in the UP position when tide is flowing from the WEST. 6 Base. 7 Top of the WEST Water Flow Entrance Chamber. 8 Top of the EAST Water Flow Entrance Chamber. 28 Spring's and the Spring Housing. The spring will be in the UP (extended position) when the tide is flowing from the WEST. 6 The Base of the invention. 26 The Anchor Support. 30 The Air Housing dispenser for the lower Encapsulation Chamber and 31 Air Housing dispenser for the EAST section of the Encapsulation Chamber. 32 The High Pressure Water Flow Section, which is the most condensed area of the water flow. 33 West flow (incoming tide) curvature section. 35 Encapsulation chamber brace. 42 The Paddles and 43 the Shaft. FIG. 4 Illustrates a closer side view of the invention specifically, 45, 46, 49 and 51. 4 hinge. 3 A water flow direction panel. A molded aluminum curved corrugated panel that will permanently encapsulate air, which makes it weightless in water. The slightest movement of water pressure against the panel will move the panel to the correct position for the incoming water flow. A water flow direction panel will be in the DOWN position when tide is flowing from the EAST. 6 The Base. 7 Top of the WEST Water Flow Entrance Chamber. 8 Top of the EAST Water Flow Entrance Chamber. The springs will be in the DOWN (lowest position) when the tide is flowing from the EAST. 26 The Anchor Support. 28 Spring's and the Spring Housing. 30 The Air Housing dispenser for the lower Encapsulation Chamber and 31 Air Housing dispenser for the EAST section of the Encapsulation Chamber. 32 The High Pressure Water Flow Section, which is the most condensed area of the water flow. 33 West flow (incoming tide) curvature section. 35 Encapsulation chamber brace. 42 The Paddles and 43 The Shaft. FIG. 5 Illustrates 1 The Encapsulated Section, which houses the watermill and allows the mill to turn with a minimal amount of drag. The integrity of the encapsulation chamber will be maintained by the 30 and 31 The Air Housing dispenser for the lower Encapsulation Chamber and Air Housing dispenser for the EAST section of the Encapsulation Chamber not shown in FIG. 5. 18 Water Flow Exit Chamber. 19 Top View of the Northern water flow Exit Director. When the current is flowing from the East, the incoming tide the exit director will be pointing towards a north west direction When the tide is flowing from the West, the exit director will be pointing towards a northeast direction. 20 Top View of the Southern water flow Exit Director. When the current is flowing from the East, (incoming tide) the exit director will be pointing towards a southwest direction. When the tide is flowing from the West, the exit director will be pointing towards a southeast direction. 23 Pivot Axle. An axle to rotate the water flow exit director with the present tide. 21 Side view of the Northern water flow director. 32 High Pressure Water Flow Section. FIG. 6 Illustrates a view from the east side of the unit with the water flow exit chamber below. 13 Water Flow Entrance Chamber Width. 14 Water Flow Entrance Chamber Height. 17 Water Flow Entrance Chamber on the East Side of the unit. 24 Water Flow Exit Chambers North side. 25 Side view of the Northern water flow director. 33 West flow (incoming tide) curvature section. FIG. 7 Illustrates a view from the Westside of the unit. 6 The Base. 13 Water Flow Entrance Chamber Width. 14 Water Flow Entrance Chamber Height. 16 Water Flow entrance Chamber on the West Side of the unit. The invention is not to be limited by what has been particularly shown and described, except as indicated by the claims.

I claim:

1. The design of the Encapsulated Chamber will allow the water mill to operate freely while submerged.

2. The design of the housing of the encapsulated chamber will allow air to be maintained while in full operation..

3. The design of a watermill that can operate below the surface of flowing water such as an ocean or a river, with minimal drag.

4. The Height, Width and Length of a Water Flow Entrance Chamber:
(A) Will determine the speed of the channeled water passing through the High Pressure Water Section.
(B) Will determine the Rpm's. of the water mill.
(C) Will determine the Torque.

5. The design of a water flowing direction panel:
(A) Is weightless in water.
(B) The movement of the panel, will be directed to the correct position by the currents water path.
(C) Will direct the flow of water in the correct path to the High Pressure Water Flow Section.
